(19) United States
(12) Patent Application Publication
(10) Pub. No.: US 2022/0194406 A1
(43) Pub. Date: Jun. 23, 2022

(54) Steering Wheel with Built-In Snooze Alert System

(71) Applicant: Bobby Ray Colvin, SR., Columbus, MS (US)

(72) Inventor: Bobby Ray Colvin, SR., Columbus, MS (US)

(21) Appl. No.: 17/539,845

(22) Filed: Dec. 1, 2021

Related U.S. Application Data
(60) Provisional application No. 63/130,284, filed on Dec. 23, 2020.

(51) Int. Cl. B60W 50/14; B62D 1/04; B60W 40/08; B60Q 5/00

(52) U.S. Cl. CPC B60W 50/14; B62D 1/046; B60W 2050/143; B60Q 5/005; B60W 2040/0818; B60W 40/08

(57) ABSTRACT

A snooze alert system comprises a steering wheel, that has an inbuilt snooze alert unit. Accordingly, the inbuilt snooze alert system may alert the driver, on detecting a loosened grip from both hands of the driver. Further, the inbuilt snooze alert system may be powered by the same vehicle's battery, thereby eliminating the need for a separate powering unit. Furthermore, the system may be controlled through buttons or switches integrated into the steering wheel, as well as through other wireless means such as a Bluetooth connection. Thus, the steering wheel with the inbuilt snooze alert system is a protective and smart addition to all vehicles.

### FIELD OF THE INVENTION

The present invention relates generally to an alert system. More specifically, the present invention is a system for alerting drivers that may be falling asleep while driving a vehicle.

### BACKGROUND OF THE INVENTION

Road accidents happening as a result of vehicle drivers dozing off is a common scenario on highways as well as on long roads. Loosened grips are the first indication from a driver who is snoozing or who is about to fall asleep. An alert in the form of a sound, a vibration, or a small electric shock to the driver, can bring the driver back to full consciousness, preventing great dangers and saving lives. In other words, an alert system that can detect the driver snoozing, can prevent majority of such road accidents. Such a system or a device that can alert a driver when the driver snoozes or falls asleep, is a rare find in the current market.

It is an objective of the present invention to alert drivers in case they fall asleep while operating a vehicle. To accomplish this, the present invention comprises a steering wheel that is inbuilt with a snooze alert system. According to a preferred embodiment of the present invention, the inbuilt snooze alert system may alert the driver on detecting a loosened grip from both hands of the driver. Further, the inbuilt snooze alert system may be powered by the same vehicle's battery, thereby eliminating the need for a separate powering unit. Furthermore, the present invention may be turned on, turned off, and controlled through buttons or switches integrated into the steering wheel, as well as through other wireless means such as a Bluetooth connection. Thus, the present invention is a protective smart addition to all vehicles that can benefit passengers of the vehicle with the snooze alert system, as well as other fellow passengers on the road.

### BRIEF DESCRIPTION OF THE DRAWINGS

FIG. 1 is a block diagram of the present invention, wherein thinner flowlines represent electrical connections between components, thicker flowlines represent electronic connections between components, and dashed flow lines represent connection between components that are communicably coupled. FIG. 2 is a flowchart illustrating an overall method of operation of the present invention. FIG. 3 is a flowchart illustrating a subprocess of the method of the snooze alert unit. FIG. 4 is a bottom perspective view of the steering wheel, according to a preferred embodiment of the present invention.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

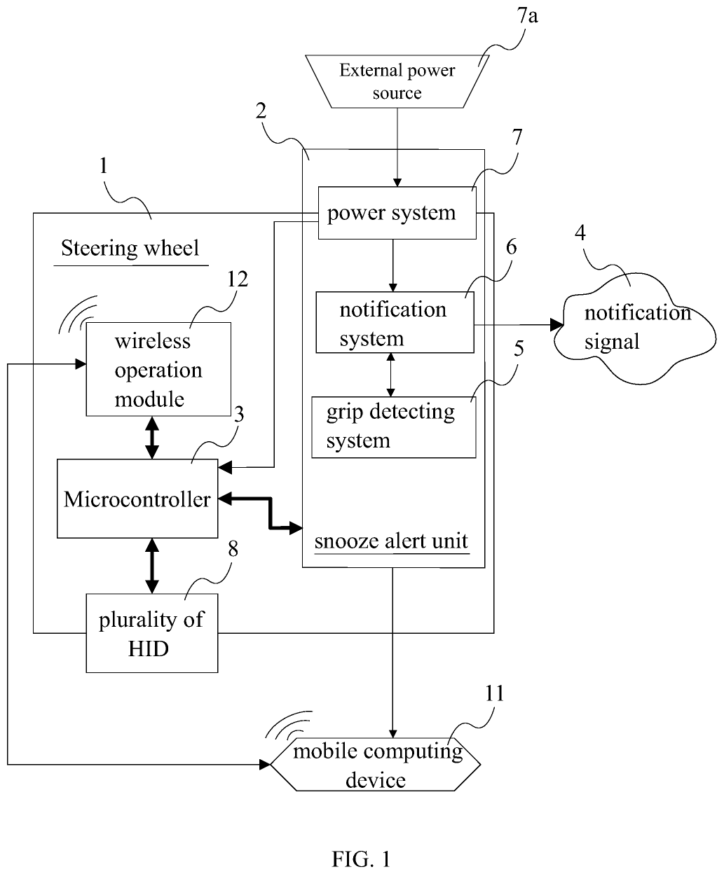

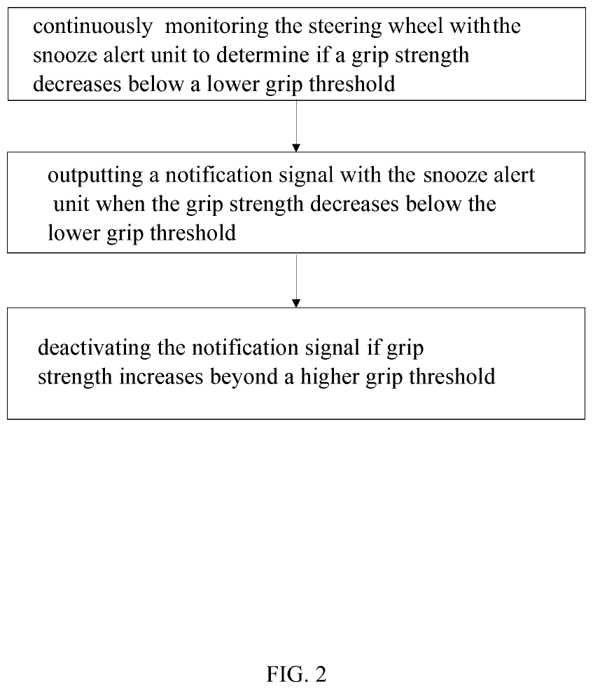

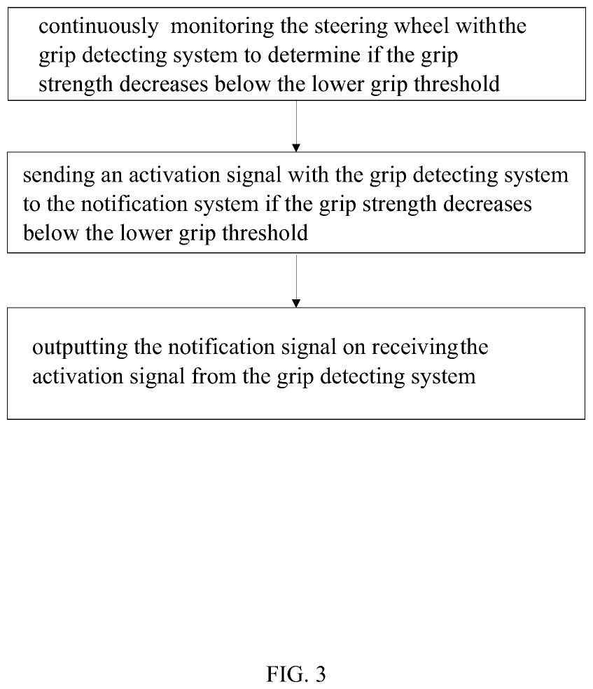

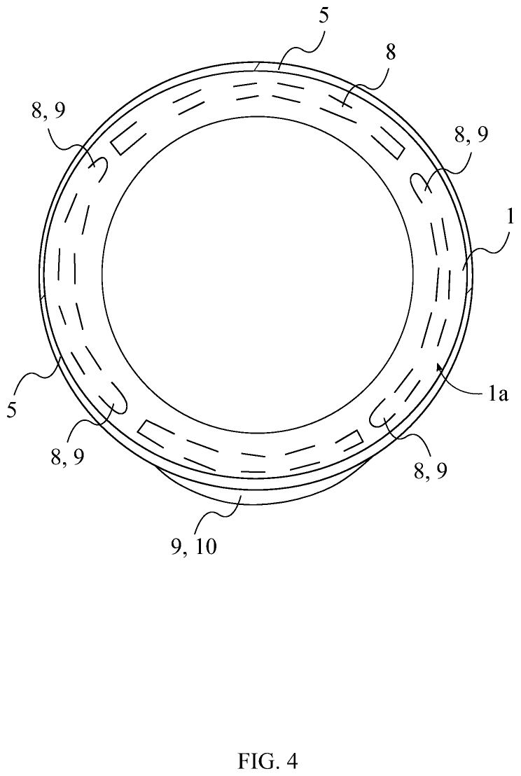

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself. In reference to FIG. 1 through FIG. 4, the present invention is a snooze alert system. It is an objective of the present invention to alert drivers in case they fall asleep or snooze while operating a vehicle. To accomplish this, the present invention comprises a steering wheel, that is inbuilt with a snooze alert unit. According to a preferred embodiment of the present invention, the inbuilt snooze alert system may alert the driver, on detecting a loosened grip from both hands of the driver. Further, the inbuilt snooze alert system may be powered by the same vehicle's battery, thereby eliminating the need for a separate powering unit. Furthermore, the present invention may be turned on, turned off, and controlled through buttons or switches integrated into the steering wheel, as well as through other wireless means such as a Bluetooth connection. Thus, the present invention is a protective smart addition to all vehicles that can benefit passengers of the vehicle having the device, as well as to other fellow passengers on the road.

The following description is in reference to FIG. 1 through FIG. 4. According to a preferred embodiment, the present invention comprises a steering wheel 1, a snooze alert unit 2, and a microcontroller 3. In order to accomplish the smooth functioning of the present invention, the snooze alert unit 2 and the microcontroller 3 are integrated into the steering wheel 1. In other words, the built-in snooze alert system is built into the vehicle's steering wheel 1 with minimal modifications, in such a way that the snooze alert unit 2 facilitate delivering a snooze alert to the user. According to the preferred embodiment, the snooze alert unit 2 comprises a group of components that may detect and alert a driver, if the driver is found to be snoozing or sleeping while operating the vehicle. The microcontroller 3 is a processing device that interprets commands received from the snooze alert unit 2 and uses these commands to manage the operation of the electrical components within the present invention. To that end, the snooze alert unit 2 is electronically connected to the microcontroller 3.

In reference to FIG. 2, and in order to accomplish the abovementioned functionalities, the present invention follows an overall method of operation. Accordingly, the method of operation comprises, continuously monitoring the steering wheel 1 with the snooze alert unit 2 for a loosened grip from both hands of a driver. In other words, present invention continuously monitors the steering wheel 1 with the snooze alert unit 2 to determine if a grip strength of the driver decreases below a predefined lower grip threshold. This is because while operating a vehicle, if the driver doses off, it will be followed by loosening or weakening of the driver's grip on the steering wheel. The predefined lower grip threshold is a value that is determined and set within the snooze alert unit 2 by the manufacturer, so as to facilitate the smooth functioning of the present invention. In order to awaken the driver, the method extends by sending a notification signal 4 to the driver with the snooze alert unit 2 upon detecting a loosened grip from both hands of the driver. In other words, the snooze alert unit 2 outputs a notification signal 4 when the grip strength decreases below the predefined lower grip threshold. Preferably, the notification signal 4 is a low power electric shock, a vibration, or an alarm sound, that could alert the driver without startling the driver. However, the notification signal 4 may comprise any other alert system and/or signal that is known to one of ordinary skill in the art, as long as the intents of the present invention are not altered. In supplemental embodiments, the notification system 6 is communicably coupled to external systems selected from the group comprising, the vehicle's audio system, external speakers, external computing devices, and display devices. These external systems are used to deliver the notification signal 4 to a user. Further, the method continues by deactivating of the notification signal 4 on receiving a firm grip from the driver, on the steering wheel 1. For example, if the notification signal 4 is an alarm, one hand of the driver gripped strongly anywhere on the steering wheel 1 will stop the alarm. A more detailed description of the present invention follows. As seen in FIG. 1, the snooze alert unit 2 comprises a grip detecting system 5, a notification system 6, and a power system 7. In the preferred embodiment, the grip detecting system 5 is able to identify a loosened grip or a grip strength below a predefined lower grip threshold from both hands of the driver. To that end, the grip detecting system 5 is mounted onto an external surface of the steering wheel 1 and the grip detecting system 5 is integrated around the steering wheel 1, as seen in FIG. 4. This is so that the grip detecting system 5 will be able to detect the grip strength of the driver regardless of where the driver has his grip on the steering wheel 1. Preferably, the grip detecting system 5 is at least one sensor device selected from the group comprising pressure sensors, capacitive sensors, touch sensors, button switches, thermal sensors, and conductivity sensor. However, any other sensor or detection technique/technology that is known to one of ordinary skill in the art may be employed for the grip detecting system 5, as long as the intents of the present invention are not altered. In some embodiments, the grip detecting system 5 comprises a plurality of sensor devices that are distributed around the steering wheel 1.

Further, the notification system 6 plays an alert or notification signal 4 when it receives an activation signal from the snooze alert unit 2. The activation signal is sent by the grip detecting system 5 to the notification system 6 on detecting a loosened grip from both hands of the driver. The activation signal preferably is an electric signal that can trigger the notification signal 4. The alert or the notification signal 4 may comprise multiple audio sounds, vibratory signals, electrical signals etc., as long as the objectives of the present invention are fulfilled. Continuing with the preferred embodiment, the power system 7 is used to deliver electrical power to the components of the present invention. Accordingly, the power system 7 is electrically connected to the microcontroller 3. Further, the power system 7 is electrically connected to the grip detecting system 5 and the notification system 6 through the microcontroller 3. Preferably, the power system 7 provides electrical power from the battery of the car/vehicle that contains the snooze alert system. In other words, the power system 7 is electrically coupled to an external power source 7a, such as a battery of the vehicle. However, any other source of power, or a combination of the following sources may be employed for the smooth functioning of the present invention. Examples of such power systems 7 include, but are not limited to, rechargeable batteries, Li ion batteries, magnetic power converters, solar power converters, etc. It is an aim of the present invention to alert drivers in case they fall asleep while operating a vehicle. To that end, the snooze alert unit 2 will be actuated only when the vehicle is in motion. In other words, the snooze alert unit 2 will not be accidently activated when the vehicle is not moving, and the driver does not have a firm grip on the steering wheel. To achieve the above-described functionality, and in reference to FIG. 3, the snooze alert unit 2 of the present invention comprises a more detailed subprocess. The subprocess includes, continuously monitoring the steering wheel 1 with the grip detecting system 5 for a loosened grip from both hands of the driver over a predefined time interval. The prefixed time interval may be selected or chosen by the driver, or a default value may be preset. Preferably, the prefixed time interval extends to a few seconds. Subsequently, the subprocess continues by sending an activation signal with the grip detecting system 5 to the notification system 6 on detecting a loosened grip from both hands of the driver. The activation signal preferably is an electric signal that can trigger the notification signal 4. In other words, on receiving the activation signal from the grip detecting system 5, the subprocess proceeds to sending the notification signal 4 to the driver with the notification system 6. Further, the activation signal may be triggered whenever the grip detecting system 5 determines that a grip strength of one or both hands has decreased below a predefined lower grip strength threshold. Likewise, the notification signal 4 may be deactivated whenever the grip detecting system 5 determines that a grip strength of one or both hands has increased beyond a predefined upper grip strength threshold.

According to the preferred embodiment, the snooze alert unit 2 is the component that is built into an existing steering wheel and is manipulated by the driver. In order to accomplish smooth operation and manipulation of the device by the driver, and as seen in FIG. 4, the present invention comprises a plurality of human interface devices (HID) 8. Preferably, the plurality of HID 8 is integrated into the steering wheel 1, and the plurality of HID 8 is electronically connected to the microcontroller 3. This is so that the plurality of HID 8 forms the platform for user interaction in order to perform the various operations of the present invention. In other words, the plurality of HID 8 is operably coupled with the snooze alert unit 2, such that operating the plurality of HID 8 governs operation of the snooze alert unit 2. For example, the plurality of HID 8 may be used to select a particular notification signal 4 from a list of different options. The plurality of HID 8 may also be used to adjust the prefixed time interval, volume of the notification signal 4, choose an after-alert contact, such as connecting to a family member, roadside assistance number, emergency contact etc. As seen in FIG. 4, the plurality of HID 8 is mounted and distributed along a first surface la of the steering wheel 1. Preferably, the plurality of HID 8 are programable electrical switches capable of opening or closing a circuit in response to a command received from an electronically connected microcontroller 3. Further, the present invention comprises a plurality of shut-off buttons 9, wherein the plurality of shut-off buttons 9 is from the plurality of HID 8. The plurality of shut-off buttons 9 is able to govern the flow of electrical current from the power system 7 to the microcontroller 3. This is so that, in case of an emergency or at any point, the driver may manually and easily turn off the system with the help of the plurality of shut-off buttons 9 that are distributed conveniently around the steering wheel 1. Furthermore, a first shut-off button 10 from the plurality of shut-off buttons 9 extends out from the steering wheel 1 adjacent to the driver. In other words, the first shut-off button 10 sticks out from the steering wheel 1 for easy accessibility and easy visibility. According to the preferred embodiment, the plurality of the HID 8 comprises squeeze buttons. However, the plurality of HID 8 may comprise any other size, shape, material, accessibility, components, and arrangement of components that are known to one of ordinary skill in the art, as long as the intents of the present invention are not altered. It is an aim of the present invention to enable the user to remotely access the controls and settings of the snooze alert system and thus adjust the various parameters according to the preference of the driver. Further, it is an aim of the present invention to enable users to actuate operation of the system either manually (by pressing a button) or wirelessly, with the help of voice activation or any other automated wireless activation methods that are known to one of ordinary skill in the art. To accomplish this, and in reference to FIG. 1, the present invention comprises a mobile computing device 11 and a wireless operation module 12. The mobile computing device 11 may be any user controllable device such as mobile phones, remote controls, tablets, other smart devices etc., that can be physically, visually, and vocally commanded.to aid in selecting a particular notification signal, set a specific parameter etc. Preferably, the mobile computing device 11 is communicably coupled with the wireless operation module 12, and the wireless operation module 12 is electronically coupled with the microcontroller 3. The wireless communication module 12 connects and communicates with external devices via wireless data transmission protocols, such that operating the mobile computing device 11 enables actuation of the snooze alert unit 2. Example standards of what the wireless communication module 12 is capable of using includes, but are not limited to,

Bluetooth, WI-FI, GSM, CDMA, ZigBee, etc. Thus, the present invention may be turned on, turned off, and controlled through buttons or switches integrated into the steering wheel 1, as well as through other wireless means such as a Bluetooth connection.

Although the invention has been explained in relation to its preferred embodiment, it is to be understood that many other possible modifications and variations can be made without departing from the spirit and scope of the invention as hereinafter claimed.

What is claimed is:

1. A snooze alert system comprising:
a steering wheel;
a snooze alert unit;
a microcontroller;
the snooze alert unit and the microcontroller being integrated into the steering wheel;
the snooze alert unit being electronically connected to the microcontroller;
continuously monitoring the steering wheel with the snooze alert unit to determine if a grip strength decreases below a predefined lower grip threshold; and
outputting a notification signal with the snooze alert unit when the grip strength decreases below the predefined lower grip threshold.

2. The snooze alert system as claimed in claim 1, comprising:
deactivating the notification signal if grip strength increases beyond a predefined higher grip threshold.

3. The snooze alert system as claimed in claim 1, comprising:
the snooze alert unit comprising a grip detecting system, a notification system, and a power system;
the grip detecting system being mounted onto an external surface of the steering wheel;
the grip detecting system being integrated around the steering wheel;
the power system being electrically connected to the microcontroller;
continuously monitoring the steering wheel with the grip detecting system to determine if the grip strength decreases below the predefined lower grip threshold over a predefined time interval;
sending an activation signal with the grip detecting system to the notification system if the grip strength is below the lower grip threshold; and
outputting the notification signal to the driver with the notification system, on receiving the activation signal from the grip detecting system.

4. The snooze alert system as claimed in claim 3, wherein the grip detecting system being at least one sensor device.

5. The snooze alert system as claimed in claim 3, wherein the grip detecting system comprising a plurality of sensor devices that are distributed around the steering wheel.

6. The snooze alert system as claimed in claim 3, wherein the notification signal being an electric shock.

7. The snooze alert system as claimed in claim 3, comprising:
the power system being electrically connected to the grip detecting system;
the power system being electrically connected to the notification system;

8. The snooze alert system as claimed in claim 3, wherein the power system being electrically connected to a battery of the vehicle.

9. The snooze alert system as claimed in claim 1, wherein snooze alert unit being actuated only when the vehicle is in motion.

10. The snooze alert system as claimed in claim 1, comprising:
a plurality of human interface devices (HID);
the plurality of HID being integrated into the steering wheel;
the plurality of HID being electronically connected to the microcontroller; and
the plurality of HID being operatively coupled with the snooze alert unit for governing the operation of the snooze alert unit.

11. The snooze alert system as claimed in claim 10, wherein the plurality of HID being mounted and distributed along a first surface of the steering wheel.

12. The snooze alert system as claimed in claim 10, comprising:
the plurality of HID comprising a plurality of shut-off buttons;
the plurality of shut-off buttons comprising a first shut-off button;
the first shut-off button protruding out from the steering wheel adjacent to the driver.

13. The snooze alert system as claimed in claim 10, wherein the plurality of the HID being squeeze buttons.

14. The snooze alert system as claimed in claim 10, comprising:
a mobile computing device;
a wireless operation module;
the mobile computing device being communicably coupled with the wireless operation module; and
the wireless operation module being electronically coupled with the microcontroller.

15. A snooze alert system for drivers on the road, the system comprising:
a steering wheel;
a snooze alert unit;
a microcontroller;
the snooze alert unit comprising a grip detecting system, a notification system, and a power system;
the snooze alert unit and the microcontroller being integrated into the steering wheel;
the snooze alert unit being electronically connected to the microcontroller;
continuously monitoring the steering wheel with the grip detecting system for a loosened grip from both hands of the driver over a prefixed time interval;
sending an activation signal with the grip detecting system to the notification system on detecting a loosened grip from both hands of the driver;
outputting a notification signal with the notification system, on receiving the activation signal from the grip detecting system; and
deactivating the notification signal on receiving a firm grip on the steering wheel from the driver.

16. The snooze alert system as claimed in claim 15, wherein the grip detecting system being at least one sensor device.

17. The snooze alert system as claimed in claim 15, wherein the notification signal being at least one of a low power electric shock, an alarm sound, and a vibration.

18. The snooze alert system as claimed in claim 15, wherein the power system being electrically connected to a battery of the vehicle.

19. The snooze alert system as claimed in claim 15, comprising:
a plurality of human interface devices (HID);
the plurality of HID being integrated into the steering wheel;
the plurality of HID being mounted and distributed along a first surface of the steering wheel;
the plurality of HID being electronically connected to the microcontroller; and
the plurality of HID being operably coupled with the snooze alert unit, such that operating the plurality of HID governs operation of the snooze alert unit.

20. The snooze alert system as claimed in claim 15, comprising:
a mobile computing device;
a wireless operation module;
the mobile computing device being communicably coupled with the wireless operation module; and
the wireless operation module being electronically coupled with the microcontroller, such that operating the mobile computing device enables actuation of the snooze alert unit.
